(19) United States
(12) Patent Application Publication
(10) Pub. No.: US 2011/0169300 A1
(43) Pub. Date: Jul. 14, 2011

(54) VAN BODY

(75) Inventor: Ronald Wise, Old Hickory, TN (US)

(73) Assignee: Wise Manufacturing, Inc., Old Hickory, TN (US)

(21) Appl. No.: 12/966,229

(22) Filed: Dec. 13, 2010

Related U.S. Application Data
(60) Provisional application No. 61/285,639, filed on Dec. 11, 2009.

(51) Int. Cl. B62D 25/00

(52) U.S. Cl. 296/181.1

(57) ABSTRACT

A van body including a canopy extending from the rear top of the van body with a camera disposed below the canopy.

### CROSS-REFERENCE TO RELATED APPLICATIONS

This Application claims the benefit of U.S. Provisional Application 61/285,639 filed on Dec. 11, 2009.

### FIELD OF THE INVENTION

The present invention relates to a design for a van and more particularly to design features of a van body.

### SUMMARY OF THE INVENTION

The object of the invention is to provide a cut-a-way vehicle (a cab-chassis vehicle that has a cab but nothing behind the rear open wall) that looks like a full-sized van from the ground up to a point that the profile of the body would have to widen to accommodate the necessary interior cargo space to make it usable. Before the present design commercial van bodies were “boxy” with flat sides. The body lines of the present invention follow the body lines of the cab up to about the bottom of the window, where they then taper away from the cab.

Cameras have been previously provided at the rear of vans. In the past this had been achieved by attaching a bracket to the surface of the body and mounting the camera to the bracket in order to place the camera in a position to view the rear bumper. This mounting arrangement is undesirable because the brackets are susceptible to damage from being hit by tree limbs, awnings, etc. The camera was sometimes unusable due to direct sunlight shining into its lens. In order to provide a better mounting point, the van body was given a “duck tail” or canopy extending from the roof line in the rear of the van with the camera mounted underneath the sloped surface at a downward angle. The “duck tail” protects the camera from damage and provides shade from direct sunlight. This design feature also allows dock lights at a loading dock to shine on the area immediately behind the vehicle.

### BRIEF DESCRIPTION OF THE DRAWINGS

FIG. 1 is a top elevational view of the van of the present invention;

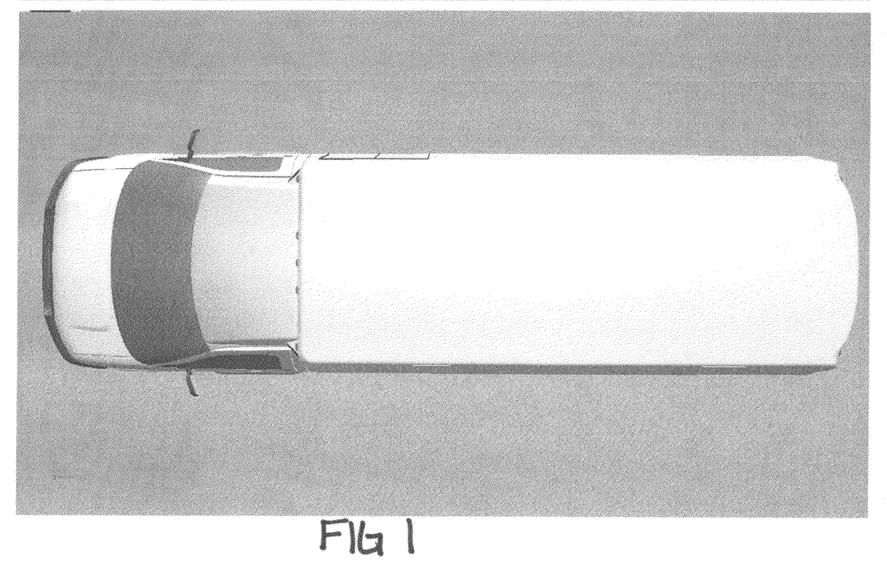

FIG. 2 is a front elevational view of a van of the invention;

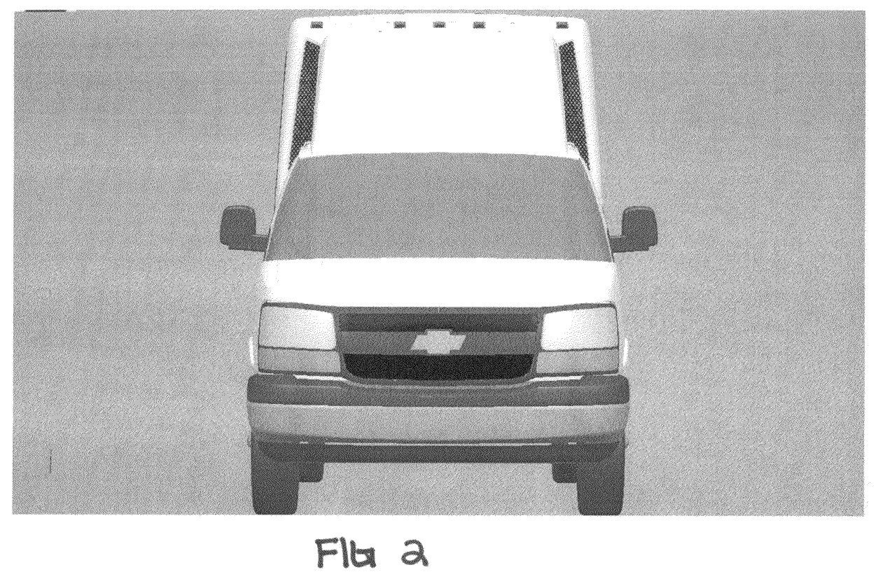

FIG. 3 is a rear elevational view of the van body showing the duck tail canopy 10 which protects the camera 12;

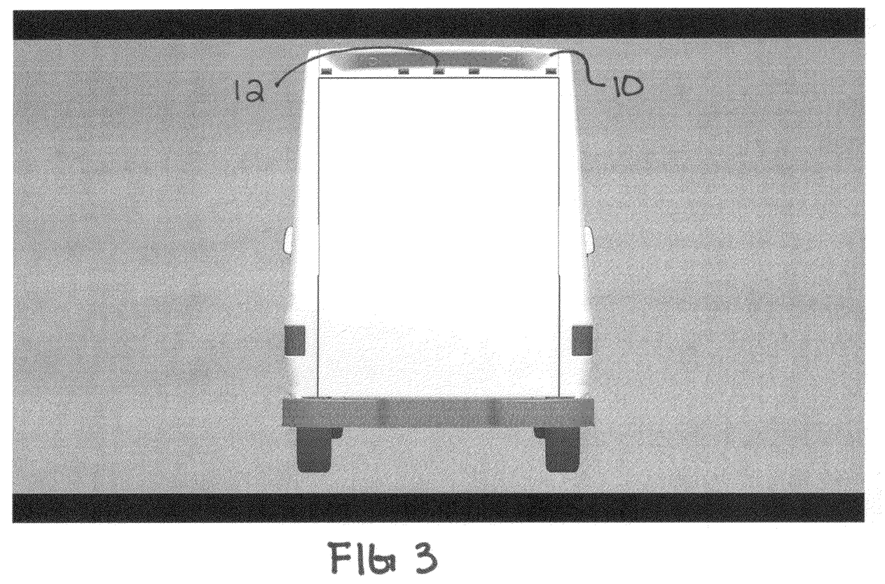

FIG. 4 is view of the van of the present invention as seen from the right side of FIG. 2 illustrating the lines 14 of van body 16 that follow the body lines 18 of the cab 20 to about the bottom of the window 22;

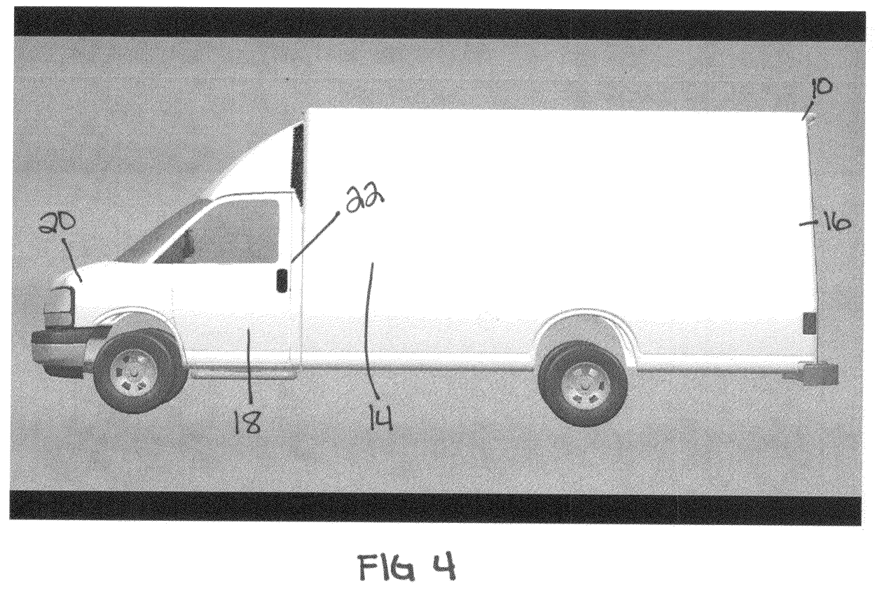

FIG. 5 is a view similar to FIG. 4 but as seen from the left side of FIG. 2; and

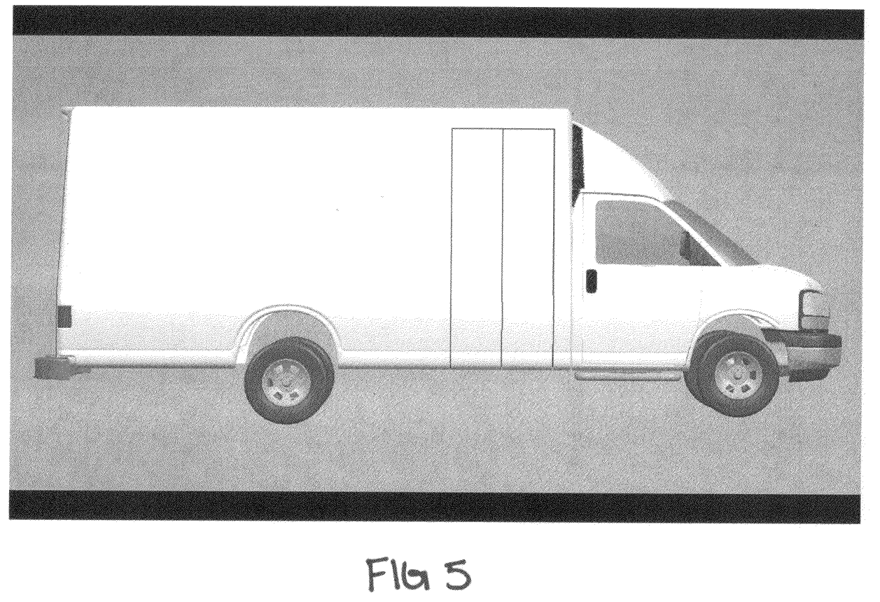

FIG. 6 is a front perspective view of the van of the present invention.

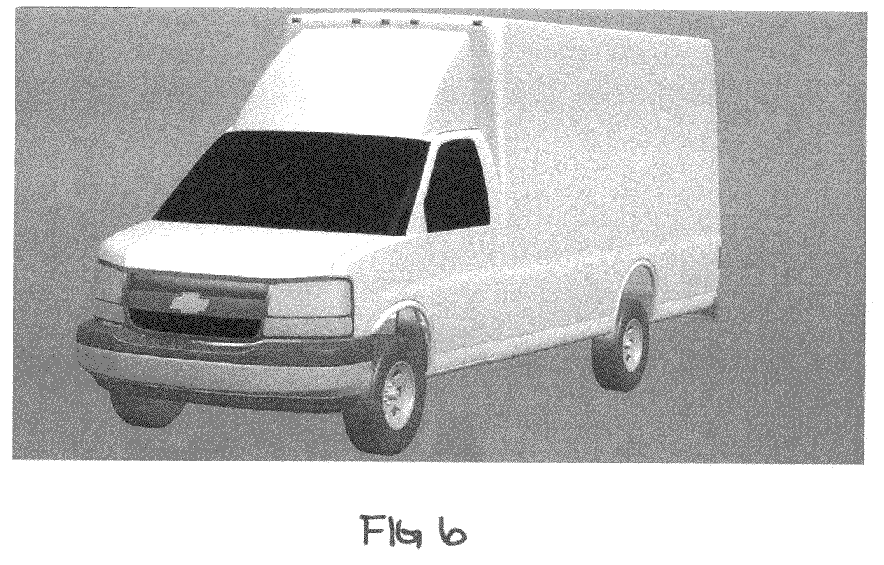

I claim:

1. A body for a van having a top and a rear;
a canopy extending from said top along the rear of said body;

2. The body as defined in claim 1 and including a camera disposed below said canopy.

3. In combination a vehicle cab and a van body extending rearwardly from said cab;
each side of said cab having a body line extending from near the front of said cab to the rear of said cab;
said van body having body lines extending from the rear of said cab to near the rear of said van body which correspond with the body lines of said cab.
